(19) United States
(12) Patent Application Publication
(10) Pub. No.: US 2007/0236779 A1
(43) Pub. Date: Oct. 11, 2007

(54) Laser display radiation source and method

(76) Inventors: Andrew H. Kung, Taipei (TW); Zhida Gao, Shen Yang City (CN); Shih-Yu Tu, Taipei County (TW); Shining Zhu, Nanjing (CN)

Correspondence Address: OCCHIUTI ROHLICEK & TSAO, LLP, 10 FAWCETT STREET, CAMBRIDGE, MA, 02138, US

(21) Appl. No.: 11/407,532

(22) Filed: Apr. 7, 2006

(51) Int. Cl. G02F 2/02

(52) U.S. Cl. 359/326

(57) ABSTRACT

In general, in one aspect, the invention features a method that includes converting radiation at a first wavelength λᵢ to radiation at a second wavelength λ_{g} and exposing an article to the radiation at λ_{g} to convert the radiation at λ_{g} to radiation at a third wavelength λᵣ and radiation at a fourth wavelength λ_{b}. λᵣ is red radiation, λ_{g} is green radiation, and λ_{b} is blue radiation and the article includes lithium tantalate.

### BACKGROUND

The disclosure relates to color projection displays that utilize a laser radiation source.

Color displays typically use three complimentary component colors to render a full color image. Conventionally, the component colors are either red, green, and blue or cyan, magenta, and violet. When provided in appropriate ratios, the three component colors combine to provide white light to an observer.

One type of display is a projection display. In certain embodiments, color projection displays superimpose three different images each composed of a different complimentary color. The result is a full color image. In general, projection displays can use a variety of different light sources. Certain projection displays use one or more lasers as their light source(s).

### SUMMARY

In certain aspects, this disclosure relates to a laser source that includes an infrared laser, and one or more nonlinear optical crystals arranged so that radiation from the infrared laser interact with the crystal(s) to emit three beams at an exit end of the crystal(s). The three beams are composed of red, green and blue radiation, respectively. The wavelengths of the colors and the intensity of each beam are arranged so that when the three beams are combined they produce the color of white light, e.g., light resembling warm daylight as defined in the CIE chromaticity diagram.

In general, in one aspect, the invention features a method that includes converting radiation at a first wavelength λᵢ to radiation at a second wavelength λ_{g}, and exposing an article to the radiation at λ_{g} to convert the radiation at λ_{g} to radiation at a third wavelength λᵣ and radiation at a fourth wavelength λ_{b}. λᵣ is red radiation, λ_{g} is green radiation, and λ_{b} is blue radiation and the article includes lithium tantalate.

Implementations of the method can include one or more of the following features and/or features of other aspects. For example, the method can include directing radiation at λᵣ, λ_{g}, and λ_{b} out of the article, wherein the radiation directed out of the optical medium at λᵣ, λ_{g}, and λ_{b} have respective intensities such that the combined radiation at λᵣ, λ_{g}, and λ_{b} directed out of the article corresponds to white radiation. Converting the radiation at λᵢ to radiation at λ_{g} can include exposing another article to the radiation at λᵢ, wherein the radiation at λᵢ interacts with the other article to produce radiation at λ_{g}. The other optical medium can include KTP, LBO, or MgO-doped PPSLT. In some embodiments, λᵢ=2λ_{g}. The radiation at λᵢ can be converted to the radiation at λ_{g} by second harmonic generation.

The article can include PPSLT or PPMgSLT. The radiation at λ_{g} can interact with the article to produce radiation at λᵣ. The radiation at λᵣ can be produced by optical parametric oscillation involving the radiation at λ_{g} and the article. The optical parametric oscillation can produce radiation at a fifth wavelength, λₙᵢᵣ, where λᵣ<λₙᵢᵣ. The radiation at λᵣ can be produced by optical parametric generation involving the radiation at λ_{g} and the article. The optical parametric generation can produce radiation at a fifth wavelength, λₙᵢᵣ, where λᵣ<λₙᵢᵣ.

Converting the radiation at λ_{g} to radiation at λ_{b} can include converting radiation at λ_{g} to radiation at a fifth wavelength, λₙᵢᵣ, where the radiation at λ_{g} and λₙᵢᵣ interact with the article to produce the radiation at λ_{b}. The radiation at λ_{b} can be produced by sum frequency generation involving the radiation at λₙᵢᵣ and λ_{g} and the article.

The method can include modulating the radiation at λᵣ, λ_{g}, and λ_{b} and directing the modulated radiation at λᵣ, λ_{g}, and λ_{b} to a viewer.

In general, in another aspect, the invention features a system that includes a laser configured to produce radiation at a first wavelength λ_{I}, a first article positioned to receive radiation from the laser at λᵢ and to convert the radiation at λᵢ to radiation at a second wavelength, λ_{g}, a second article comprising lithium tantalite, the second article being positioned to receive the radiation at λ_{g} and to convert radiation at λ_{g} to radiation at a third wavelength, λᵣ, and radiation at a fourth wavelength, λ_{b}. λᵣ is red radiation, λ_{g} is green radiation, and λ_{b} is blue radiation.

Embodiments of the system can include one or more of the following features and/or features of other aspects. For example, the laser can be a pulsed laser. λᵢ can be infrared radiation. The first article can include KTP, LBO, or PPMgSLT. The second article can include a first portion that includes a plurality of inverted domain regions arranged to produce the radiation at λᵣ and radiation at a fifth wavelength, λₙᵢᵣ, when the radiation at λ_{g} interacts with the first portion. The second article can include a second portion that includes a plurality of inverted domain regions arranged to produce the radiation at λ_{b} when the radiation at λₙᵢᵣ and λ_{g} interacts with the second portion. The first and second portions can have dimensions l₁ and l₂, respectively, such that a relative intensity of radiation at λᵣ, λ_{g}, and λ_{b} exiting the second article in combination corresponds to white radiation. The second article can include opposing faces that are dielectric multilayer coated to form an optical cavity having a resonant wavelength at λᵣ. The second article can include one or more dielectric-coated mirrors to form an optical cavity having a resonant wavelength at λᵣ. The lithium tantalate can include PPSLT or PPMgSLT.

In some embodiments, the system includes a first modulator positioned to receive radiation at λᵣ exiting the second article, a second modular positioned to receive radiation at λ_{g} exiting the second article, and a third modulator positioned to receive radiation at λ_{b} exiting the second article. The system can include an electronic controller in communication with the first, second, and third modulators, the electronic controller being configured to cause the first, second, and third modulators to modulate an intensity profile of the radiation at λᵣ, λ_{g}, and λ_{b}, respectively, to form an image at a viewing region.

In general, in a further aspect, the invention features a system that includes a source configured to provide radiation at a first wavelength λ_{I}, a means for frequency doubling the radiation at λᵢ to produce radiation at a second wavelength λ_{g}, a means for parametrically converting radiation at λ_{g} to radiation at a third wavelength λᵣ and a fourth wavelength λₙᵢᵣ, and for converting the radiation at λ_{g} and λₙᵢᵣ to radiation at a fifth wavelength, λ_{b}. λᵣ is red radiation, λ_{g} is green radiation, and λ_{b} is blue radiation. Embodiments of the system can include any of the features of the aforementioned aspects.

Among other advantages, embodiments feature laser display systems that are relatively simple and compact. For example, laser display systems can be composed of just a few components and fewer adjustable parts. Embodiments of laser display systems do not require additional optics to separate the three complimentary colors. For example, by tilting slightly (e.g., at an angle less than about 5 degrees, less than about 3 degrees, less than about 2 degrees, such as between about 1 and about 2 degrees) the angle between an input beam and an alignment direction of the inverted domains in a nonlinear crystal, the complimentary color beams can naturally exit the crystal in three different directions. No additional dispersive optics are needed to separate the colors.

Embodiments of laser display systems can be relatively efficient. For example, in some embodiments, the total output power of the display system essentially equals the power of the source (e.g., the exciting laser). The overall wall-plug efficiency can be more than 0.1% (e.g., about 0.5% or more, about 1% or more, about 2% or more, about 5% or more).

Embodiments of laser display systems can be relatively robust. For example, certain display systems operate above room temperature and are regulated so that temperature fluctuations are relatively small (e.g., regulated to +/−0.15 degrees C.). Being above ambient temperature, embodiments of laser display systems are not substantially affected by changes to the environmental conditions. Furthermore, in embodiments, nonlinear crystals used in laser display systems can have relatively long lifetimes at the elevated temperatures.

In some embodiments, laser display systems can provide high quality images. For example, embodiments can automatically reduce laser speckle. The process of generating a longer wavelength (e.g., red) beam can be a high gain parametric process, with a relatively high bandwidth and consequently relatively low coherence. Associated complimentary beams (e.g., blue beams) have correspondingly low coherence. Low coherence light in turn results in low speckle. In some embodiments, a random phase plate can be added to other beams to reduce its spatial coherence and corresponding speckle.

Laser display systems can be readily adapted for dynamic display. For example, in some embodiments, modulators can be positioned in the path of each complimentary beam at the output end of the device, allowing the display system to change the relative intensity of the complimentary beams to produce a display's visible effect.

Applications include systems for video display and entertainment (e.g., laser) shows.

The details of one or more embodiments are set forth in the accompanying drawings and the description below. Other features and advantages will be apparent from the description, drawings, and the claims.

### DESCRIPTION OF DRAWINGS

FIG. 1 is a schematic diagram of an embodiment of a display system.

FIG. 2 is a schematic diagram of an embodiment of a component for use in a display system.

FIG. 3 is a schematic diagram of components of an embodiment of a display system.

FIG. 4 is a schematic diagram of components of an embodiment of a display system.

FIG. 5 is a schematic diagram of components of an embodiment of a display system.

FIG. 6 is a schematic diagram of components of an embodiment of a display system.

Like reference symbols in the various drawings indicate like elements.

### DETAILED DESCRIPTION

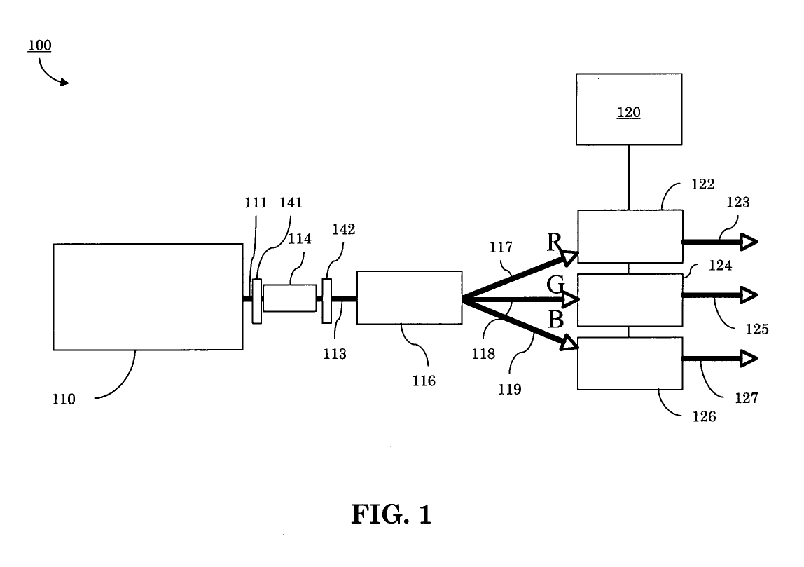

Referring to FIG. 1, a display system 100 includes a laser 110, a first non-linear optical medium 114, a second non-linear optical medium 116, and three modulator/scanner units 122, 124, and 126. Laser 110 provides input radiation 111 through element(s) 141 (e.g., a lens, a polarizer, a waveplate, and/or a filter) to first non-linear optical medium 114. Radiation 113 exits first non-linear optical medium 114, passes through element(s) 142 (e.g., a lens, a mirror, and/or a filter) and enters second non-linear optical medium 116, which emits three radiation beams 117, 118, and 119 to modulator/scanner units 122, 124, and 126, respectively. Modulator/scanner units 122, 124, and 126 direct respective modulated beams 123, 125, and 127 out of display system 100 for display to a viewer. Display system 100 also includes an electronic controller 120 (e.g., a computer processor), which is in communication with modulator/scanner units 122, 124, and 126 and provides information to these units related to the image to be displayed.

During operation, laser 110 provides radiation 111 at a wavelength λᵢ. First non-linear optical medium 114 converts a portion of the incident radiation at λᵢ into radiation at another wavelength, λ_{g}.

Radiation 113 at λᵢ and λ_{g} exits first non-linear optical medium 114 and enters second non-linear optical medium 116, which converts some of the radiation at λᵢ and λ_{g} into radiation at wavelengths λᵣ and λ_{b}. These conversion processes are discussed below. Radiation at λᵣ, λ_{g}, and λ_{b} exits second optical medium 116 (shown as beams 117, 118, and 119, respectively) along different paths.

Beam 117 at λᵣ is directed to modulator/scanner 122, beam 118 at λ_{g} is directed to modulator/scanner 124, and beam 119 at λ_{b} is directed to modulator/scanner 126. The modulator/scanners encode information into the respective beams, providing modulated beams 123, 125, and 127, respectively. The information encoded into the beams typically includes spatial and temporal modulations that result in the beams providing an image (e.g., a dynamic image) to a viewing space (e.g., a screen). The information is provided to the modulator/scanners by electronic controller 120. Examples of modulators/scanners include MEMS devices (e.g., Digital Micromirror Devices (DMD)), scanning mirrors (e.g., mirrors mounted on one or more actuators, such as scanning galvanometers), grating light valves (GLVs), and liquid crystal spatial light modulators.

Typically, λᵣ, λ_{g}, and λ_{b} are at red, green, and blue wavelengths respectively. For example, λᵣ is in a range from about 600 nm to about 700 nm, λ_{g} is in a range from about 500 nm to about 560 nm, and λ_{b} is in a range from about 400 nm to about 490 nm.

In general, the relative intensities of the radiation at λᵣ, λ_{g}, and λ_{b} in beams 117, 118, and 119, respectively, can vary. For example, the ratio of intensities at λᵣ to λ_{g} can be greater than 1 (e.g., about 1.2 or more, about 1.4 or more, about 1.5 or more). The ratio of intensities at λ_{g} to λ_{b} can be greater than 1 (e.g., about 1.5 or more, about 1.8 or more, about 2 or more, about 2.2 or more). In some embodiments, the ratio of intensities at λᵣ:λ_{g}:λ_{b} are about 2:1.4:1. In certain embodiments, the wavelengths and relative intensities are selected so that the combination of the radiation at λᵣ, λ_{g}, and λ_{b} corresponds to white light as defined by its CIE chromaticity co-ordinates. For example, the combination of the radiation in beams 117, 118, and 119 can have chromaticity co-ordinates x and y in a range from about 0.25 to about 0.4 (e.g., about 0.33). In some embodiments, the combination of the radiation in beams 117, 118, and 119 provides white light corresponding to a color correlated temperature (CCT) of about 4,800 K or more (e.g., about 5,000 K or more, about 5,200 K or more, about 5,400 K or more, about 5,600 K or more).

Generally, laser 110 is an infrared laser and radiation 111 is at a wavelength λᵢ in a range from about 900 nm to about 2,000 nm (e.g., 1064 nm). λᵢ is selected based on the conversion properties of the first and second non-linear optical media so that the output wavelengths of system 100 are at desired wavelengths (e.g., so that the λᵣ, λ_{g}, and λ_{b} are red, green, and blue wavelengths, respectively).

Typically, laser 110 is a pulsed laser, and radiation 111 is emitted in pulses at frequencies in the range of about 1 kHz or more (e.g., about 10 kHz or more, about 20 kHz or more). Pulse duration can vary, and is typically in the range of 1 to 100 nanoseconds (e.g., about 10 nanoseconds), although, in certain embodiments, picosecond and sub-picosecond pulses can be used.

Further, laser 110 provides radiation 111 at sufficient power to interact with first and second non-linear optical media 114 and 116 to produce the radiation at λᵣ, λ_{g}, and λ_{b}. For example, in some embodiments, laser 110 can have a peak output power of about 10 kW or more (e.g., about 50 kW or more, about 100 kW or more. As used herein, peak power for a pulsed laser refers to the ratio of the energy per pulse (in Joules) to the pulse duration (in seconds).

First non-linear optical medium 114 converts radiation at λᵢ to radiation at λ_{g} by a non-linear optical process. In certain embodiments, the conversion process used by medium 114 is second harmonic generation. Accordingly, in these embodiments, 2λ_{g}=λᵢ. First non-linear medium 114 is composed of material(s) selected based on the desired conversion process and wavelength λᵢ. First non-linear medium 114 can be composed of Potassium Titanium Oxide Phosphate (KTP), Lithium Triborate (LBO), and/or MgO-doped periodically-poled stoichiometric lithium tantalate (PPMgSLT).

Second non-linear optical medium 116 converts radiation at λᵢ and λ_{g} to radiation at λᵣ and λ_{b} by one or more non-linear optical processes. In some embodiments, these processes can include optical parametric oscillation which involves transfer of power at λ_{g} to radiation at wavelengths λᵣ and another wavelength λₙᵢᵣ (e.g., λₙᵢᵣ>λᵣ). The non-linear optical process can also include sum frequency generation where power at λₙᵢᵣ and λ_{g} are transferred to λ_{b}.

Second non-linear optical medium 116 is formed from one or more materials selected based on the desired conversion processes and wavelengths of operation of the system. Second non-linear optical medium 116 can be formed, for example, from PPSLT or PPMgSLT.

In some embodiments, second non-linear optical medium 116 includes an optical cavity for radiation at one or more of wavelengths λₙᵢᵣ, λᵣ, λ_{g}, or λ_{b}. For example, in some embodiments, non-linear optical medium 116 can have its entry face dielectric multilayer coated for high reflectivity (e.g. >99%) at λᵣ and high transmission (e.g. >95%) at λ_{g} and its exit face dielectric multilayer coated for partial reflectivity (e.g. <100%) at λᵣ and high transmission (e.g. >95%) at λ_{g} and λ_{b} so that medium 116 forms a monolithic optical cavity and have radiation at λᵣ, λ_{g}, and λ_{b} exit as beam 117.

In some embodiments, nonlinear optical medium 116 can be placed between elements (e.g., mirrors, such as dielectric multilayer mirrors) that are highly reflective at λᵣ in order to increase the intensity of the radiation at this wavelength in second non-linear optical medium 116. The reflector at the output side of second non-linear optical medium 116 should have a reflectivity less than 100% at λᵣ in order to allow radiation at λᵣ to exit as beam 117.

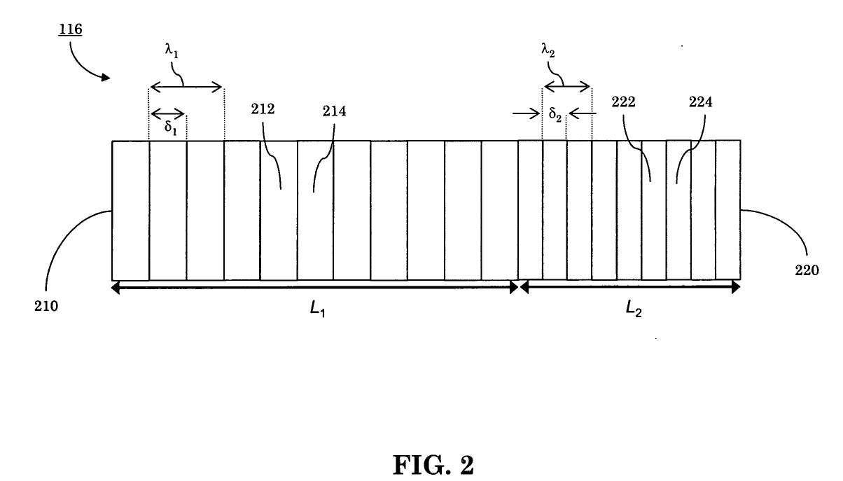

Referring to FIG. 2, in some embodiments, second non-linear optical medium 116 is a non-linear crystal composed of two portions, portion 210 and portion 220, respectively. Medium 116 has an overall length, L, along one dimension where the length of portion 210 is L₁ and the length of portion 220 is L₂.

First portion of length L₁ has domain sections 212 and inverted domain sections 214 periodically arranged along length L₁. Sections 212 and 214 have a spatial period of λ₁, where sections 214 have a width δ₁ and sections 212 have a width λ₁-δ₁.

L₁, λ₁, and δ₁ are selected to provide gain in a parametric process to provide radiation at λᵣ and λₙᵢᵣ when the first portion is excited by the radiation at λ_{g}. In particular, λ₁ and δ₁ are selected, along with the orientation of second non-linear optical medium 116, so that quasi phase matching (QPM) is achieved in portion 210.

Second portion 220 of length L₂ has domain sections 222 and inverted domain sections 224 periodically arranged along length L₂. Domain sections 222 and 224 have a spatial period of λ₂, where sections 224 have a width δ₂ and sections 222 have a width λ₂-δ₂.

In second portion 220, L₂, λ₂, and δ₂ are selected so that the interaction of the radiation at λₙᵢᵣ and λ_{g} with the second portion provides radiation at λ_{b}. λ₂ and δ₂ are selected, along with the orientation of second non-linear optical medium 116, so that quasi phase matching is achieved in portion 220.

The lengths L₁ and L₂ are chosen so that the resulting intensities of beams 117, 118, and 119 provide the desired ratios of red, green, and blue (e.g., so that their combination results in the desired shade of white light).

While the foregoing embodiment of second non-linear optical medium 116 includes periodic inverted domain sections, other configurations are also possible. In general, the sections in either the first and/or second portions can be periodically, aperiodically or quasi-periodically arranged. Periodic arrangements can give the highest parametric gain. However, in certain embodiments, aperiodic or quasiperiodic sections can give better tolerances on the temperature and wavelength stability compared to periodic sections.

In general, first and second non-linear optical crystals 114 and 116 can be bulk crystals, in the form of a planar waveguide, or in the form of a fiber waveguide.

In some embodiments, first non-linear optical medium 114 and/or non-linear optical medium 116 are maintained at an elevated temperature (e.g., greater than room temperature). The first and/or second non-linear optical media can be maintained at a temperature of about 100° C. or more (e.g., about 120° C. or more, about 140° C. or more, about 160° C. or more, about 180° C. or more, about 200° C. or more).

Embodiments can include one or more heaters arranged to heat the first and/or second non-linear optical medium. For example, the first and/or second non-linear optical media can be positioned adjacent an electrical heating element. A thermocouple can be used to monitor the temperature of the first and/or second non-linear optical media and provide feedback to the heater to maintain the media temperature within a desired range.

As a specific example, laser 110 is a diode-laser-pumped all solid-state Nd:YAG laser that provides infrared pulses of several nanosecond in duration at about 1064 nm (λᵢ) and a pulse repetition rate of about 10 kHz or more. The first non-linear optical medium is a type II phase-matched KTP crystal. This frequency doubles the 1064 nm radiation to generate radiation at 532 nm (λ_{g}). The generated 532 nm light is focused with a lens to a beam waist of about 100 μm into the second non-linear optical medium which is a QPM crystal. The QPM crystal is PPSLT with L₁ of about 2.5 cm having periodically-poled domains with a domain period of about 11.7 μm. L₂ is about 1.5 cm with periodically-poled domains having a domain period of about 8.5 μm. The crystal is about 5 mm wide and about 1 mm thick. The crystal temperature is maintained at about 160° C. The input end of the crystal is dielectric coated for high reflection (e.g., of about 99% or more) at 633 nm, and anti-reflection (e.g., providing reflection of about 1% or less) at 532 nm. The output end of the crystal is coated for about 50% reflecting at 633 nm, and anti-reflection (e.g., providing reflection of about 1% or less) at 532 nm and 460 nm. With these parameters, the output wavelengths are 633 nm (red), 532 nm (green) and 459 nm (blue). Since the crystal does not substantially absorb at any of these wavelengths, the sum of the powers of the three outputs will approximately equal to the power of the input at 532 nm. The ratio of the power of the three colors can be adjusted to the ratio of 2:1.4:1, corresponding to warm daylight color. The intensity of the green input is about 40 MW/cm², which approximately 5 or more times above threshold. This is a level that is substantially safe from optical damage to the crystal surface. While the input beam is generally circularly shaped, it could be oblong with a major-axis to minor-axis ratio of up to about 3 to accommodate higher power applications.

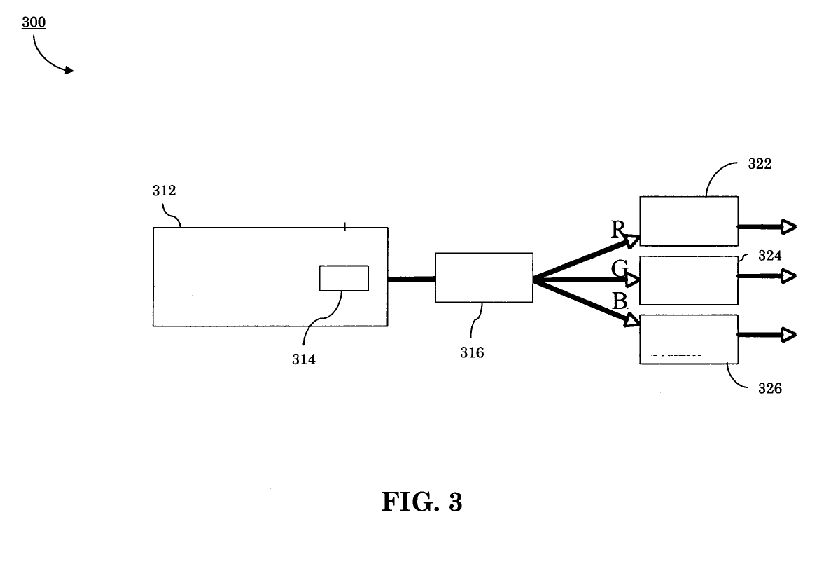

In system 100, both first and second non-linear optical media are placed outside of laser 110. However, in general, other placements of the non-linear optical media are possible. For example, in another variation, the first non-linear optical medium can be incorporated into the laser (e.g., within the optical cavity of the laser). Referring to FIG. 3, a display system 300 includes a laser 312, a first non-linear optical medium 314, a second non-linear optical medium 316, and three modulator/scanners 322, 324, and 326. First non-linear optical medium 314 is positioned within laser 312 and the laser is arranged to emit radiation at λ_{g} rather than λᵢ. The operation is otherwise the same as system 100.

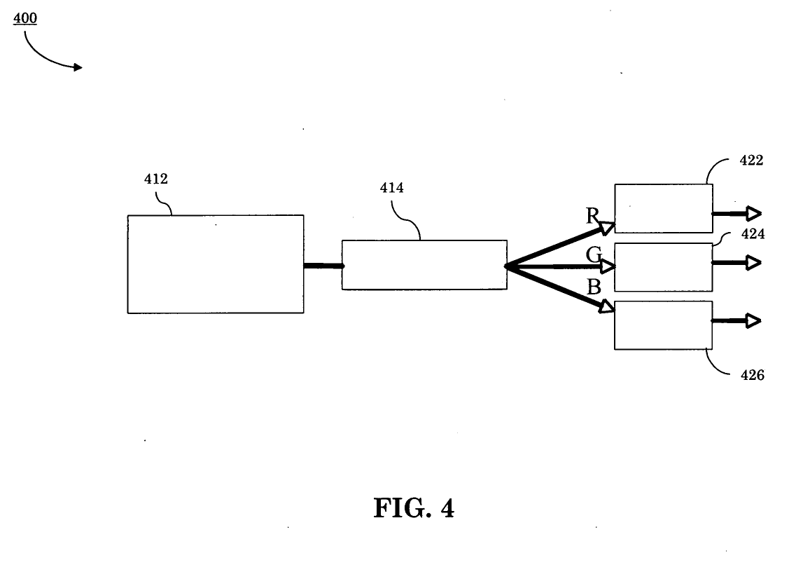

In certain embodiments, the first and second non-linear optical media can be combined into a single article. For example, referring to FIG. 4, a display system 400 includes a laser 412, a non-linear optical medium 414, and three modulator/scanners 422, 424, and 426. Non-linear optical medium 414 includes a first portion that provides the same function as the first non-linear optical medium in system 100. Non-linear optical medium 414 also includes another portion that provides the function of the second non-linear optical medium in system 100.

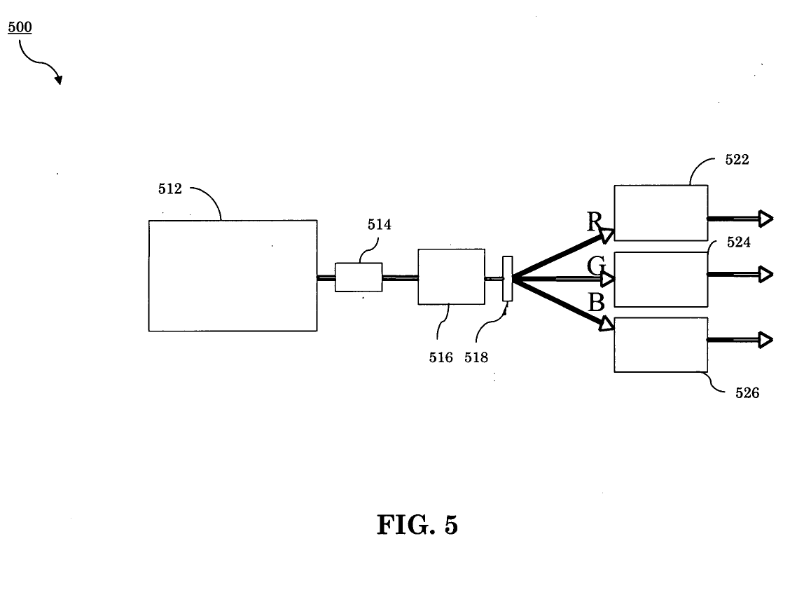

In general, display systems can include components in addition to those described in relation to systems 100, 300, and 400 above. For example, referring to FIG. 5, a display system 500 includes a dielectric mirror 518 positioned between a second non-linear optical medium 516 and modulator/scanners 522, 524, and 526. System 500 also includes a laser 512 and a first non-linear optical medium 514. Dielectric mirror 518 is configured to reflect a portion (e.g., about 30% to about 70%) of the incident radiation at λᵣ, while transmitting substantially all (e.g., about 99% or more) incident radiation at λ_{g} and λ_{b}. The surface of second non-linear optical medium 516 can be anti-reflection coated for radiation at λᵣ, λ_{g}, and λ_{b}.

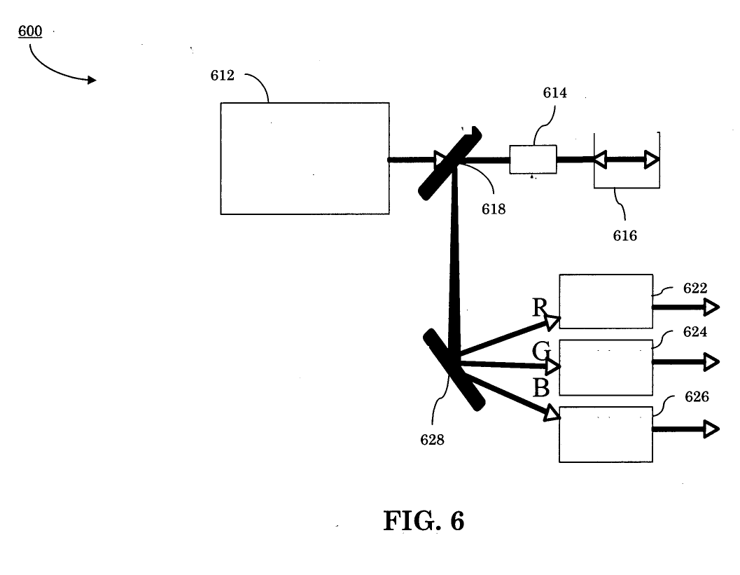

Other configurations are also possible. For example, referring to FIG. 6, a display system 600 includes a laser 612 (e.g., picosecond or subpicoseond high peak power (e.g., >100 kW) laser), a first non-linear optical medium 614, a second non-linear optical medium 616 aligned with portion L₂ near laser 612 and portion L₁ away from laser 612, and modulator/scanners 622, 624, and 626. In addition, display system 600 includes a mirror 618 positioned between laser 612 and the non-linear optical media. Mirror 618 (e.g., a dielectric multilayer mirror) is configured to substantially transmit radiation at λᵢ, but substantially reflect radiation at λᵣ, λ_{g}, and λ_{b}. An additional mirror 628 is positioned to direct radiation reflected by mirror 618 towards modulator/scanners 622, 624, and 626. Further, second non-linear optical medium 616 includes a reflective coating on its surface facing away from laser 612, which substantially reflects radiation at λᵣ and λ_{g}.

In a specific example, pump laser 612 is a mode-locked solid state laser operating at more than about 10 MHz. In this case, second non-linear optical medium 616, a QPM crystal, has an anti-reflection coating on the side near L₂, and is high reflection coated for both the green and the red colors on the side near L₁. The infrared output from the laser is frequency doubled to the green by first non-linear optical medium 114, a QPM crystal, and is focused into 2 second non-linear optical medium 616 from the side that is antireflection coated to a Gaussian spot size (waist size) of about 40-60 μm centered at the high reflection face of the crystal. The focused intensity is in a range of about 1-10 GW/cm². In this case the parametric gain is high and second non-linear optical medium operates as a double-pass parametric generator. On the second pass before departing the non-linear optical medium, the residual green frequency mixes with the idler wavelength (λₙᵢᵣ) generated in the parametric process to produce the blue beam. The red, green and blue beams exit the crystal after two passes of the green in the crystal and are separated from the infrared beam by a dichroic mirror. An advantage of this example is the monolithic crystal can produce a RGB laser beam at multi-MHz repetition rate, suitable for use in laser projection systems that require such high repetition rates.

While certain embodiments have been described, other configurations are also possible. For example, embodiments can include one or more additional optical components, such as additional lenses, polarizers, waveplates, and/or filters For example, while the foregoing examples produce white light by generating a red, green, and blue beam, in some embodiments other colors can be produced. For example, in some embodiments, the system can be configured to produce cyan, magenta, and yellow beams to provide white light.

Other embodiments are in the following claims.

What is claimed is:

1. A method, comprising:
converting radiation at a first wavelength λᵢ to radiation at a second wavelength λ_{g}; and
exposing an article to the radiation at λ_{g} to convert the radiation at λ_{g} to radiation at a third wavelength λᵣ and radiation at a fourth wavelength λ_{b},
wherein λᵣ is red radiation, λ_{g} is green radiation, and λ_{b} is blue radiation and the article comprises lithium tantalate.

2. The method of claim 1 further comprising directing radiation at λᵣ, λ_{g}, and λ_{b} out of the article, wherein the radiation directed out of the optical medium at λᵣ, λ_{g}, and λ_{b} have respective intensities such that the combined radiation at λᵣ, λ_{g}, and λ_{b} directed out of the article corresponds to white radiation.

3. The method of claim 1 wherein converting the radiation at λᵢ to radiation at λ_{g} comprises exposing another article to the radiation at λᵢ, wherein the radiation at λᵢ interacts with the other article to produce radiation at λ_{g}.

4. The method of claim 1 wherein the other optical medium comprises KTP, LBO, or MgO-doped PPSLT.

5. The method of claim 1 wherein λᵢ=2λ_{g}.

6. The method of claim 1 wherein the radiation at λᵢ is converted to the radiation at λ_{g} by second harmonic generation.

7. The method of claim 1 wherein the article comprises PPSLT or PPMgSLT.

8. The method of claim 1 wherein the radiation at λ_{g} interacts with the article to produce radiation at λᵣ.

9. The method of claim 8 wherein the radiation at λᵢ is produced by optical parametric oscillation involving the radiation at λ_{g} and the article.

10. The method of claim 9 wherein the optical parametric oscillation produces radiation at a fifth wavelength, λₙᵢᵣ, where λᵣ<λₙᵢᵣ.

11. The method of claim 8 wherein the radiation at λᵣ is produced by optical parametric generation involving the radiation at λ_{g} and the article.

12. The method of claim 11 wherein the optical parametric generation produces radiation at a fifth wavelength, λₙᵢᵣ, where λᵣ<λₙᵢᵣ.

13. The method of claim 1 wherein converting the radiation at λ_{g} to radiation at λ_{b} comprises converting radiation at λ_{g} to radiation at a fifth wavelength, λₙᵢᵣ, where the radiation at λ_{g} and λₙᵢᵣ interact with the article to produce the radiation at λ_{b}.

14. The method of claim 13 wherein the radiation at λ_{b} is produced by sum frequency generation involving the radiation at λₙᵢᵣ and λ_{g} and the article.

15. The method of claim 1 further comprising modulating the radiation at λᵣ, λ_{g}, and λ_{b} and directing the modulated radiation at λᵣ, λ_{g}, and λ_{b} to a viewer.

16. A system, comprising:
a laser configured to produce radiation at a first wavelength λᵢ;
a first article positioned to receive radiation from the laser at λᵢ and to convert the radiation at λᵢ to radiation at a second wavelength, λ_{g}; and
a second article comprising lithium tantalite, the second article being positioned to receive the radiation at λ_{g} and to convert radiation at λ_{g} to radiation at a third wavelength, λᵣ, and radiation at a fourth wavelength, λ_{b},
wherein λᵣ is red radiation, λ_{g} is green radiation, and λ_{b} is blue radiation.

17. The system of claim 16, wherein the laser is a pulsed laser.

18. The system of claim 16 wherein λᵢ is infrared radiation.

19. The system of claim 16 wherein the first article comprises KTP, LBO, or PPMgSLT.

20. The system of claim 16 wherein the second article comprises a first portion that includes a plurality of inverted domain regions arranged to produce the radiation at λᵣ and radiation at a fifth wavelength, λₙᵢᵣ, when the radiation at λ_{g} interacts with the first portion.

21. The system of claim 20 wherein the second article further comprises a second portion that includes a plurality of inverted domain regions arranged to produce the radiation at λ_{b} when the radiation at λₙᵢᵣ and λ_{g} interacts with the second portion.

22. The system of claim 21 wherein the first and second portions have dimensions l₁ and l₂, respectively, such that a relative intensity of radiation at λᵣ, λ_{g}, and λ_{b} exiting the second article in combination corresponds to white radiation.

23. The system of claim 20 wherein the second article comprises opposing faces that are dielectric multilayer coated to form an optical cavity having a resonant wavelength at λᵣ.

24. The system of claim 20 wherein the second article comprises one or more dielectric-coated mirrors to form an optical cavity having a resonant wavelength at λᵣ.

25. The system of claim 16 wherein the lithium tantalate comprises PPSLT or PPMgSLT.

26. The system of claim 16 further comprising a first modulator positioned to receive radiation at λᵣ exiting the second article, a second modular positioned to receive radiation at λ_{g} exiting the second article, and a third modulator positioned to receive radiation at λ_{b} exiting the second article.

27. The system of claim 16 further comprising an electronic controller in communication with the first, second, and third modulators, the electronic controller being configured to cause the first, second, and third modulators to modulate an intensity profile of the radiation at λᵣ, λ_{g}, and λ_{b}, respectively, to form an image at a viewing region.

28. A system comprising:
a source configured to provide radiation at a first wavelength λᵢ;
a means for frequency doubling the radiation at λᵢ to produce radiation at a second wavelength λ_{g};
a means for parametrically converting radiation at λ_{g} to radiation at a third wavelength λᵣ and a fourth wavelength λₙᵢᵣ, and for converting the radiation at λ_{g} and λₙᵢᵣ to radiation at a fifth wavelength, λ_{b},
wherein λᵣ is red radiation, λ_{g} is green radiation, and λ_{b} is blue radiation.
